(19) United States
(12) Patent Application Publication
(10) Pub. No.: US 2020/0048133 A1
(43) Pub. Date: Feb. 13, 2020

(54) ARTICLES HAVING EDGES WITH COMPRESSIVE RESIDUAL STRESS AND METHODS OF FORMING THE SAME

(71) Applicant: Corning Incorporated, Corning, NY (US)

(72) Inventors: Stuart Gray, Corning, NY (US); Todd LeRoy Heck, Millerton, PA (US); Yi-Cheng Hsieh, Horseheads, NY (US)

(21) Appl. No.: 16/523,330

(22) Filed: Jul. 26, 2019

Related U.S. Application Data
(60) Provisional application No. 62/716,618, filed on Aug. 9, 2018.

(51) Int. Cl. C03B 17/06; B24B 9/10; C03B 33/023

(52) U.S. Cl. CPC C03B 17/06; C03B 33/023; B24B 9/10

(57) ABSTRACT

Articles with at least one finished edge and methods and systems for forming the same are disclosed. A method of forming a glass article having at least one finished edge includes heating a substrate to a preparation temperature, the substrate having at least one unfinished edge, applying a laser to the at least one unfinished edge of the substrate, the laser causing a temperature of the at least one unfinished edge to increase from the preparation temperature to a finishing temperature, and reducing a power of the laser over a time period of at least about 10 seconds until the laser is deactivated, resulting in the glass article comprising the at least one finished edge.

This application claims the benefit of priority to U.S. Provisional Application Ser. No. 62/716,618 filed on Aug. 9, 2018, the content of which is relied upon and incorporated herein by reference in its entirety.

### BACKGROUND

### Field

The present disclosure generally relates to articles having finished edges and methods and systems for forming the same. In particular, the present disclosure is directed to articles having edges exhibiting compressive residual stress, as well as to laser thermal finishing processes for fabricating such articles.

### Technical Background

Thin substrates, such as glass sheets, glass wafers, and/or the like, have been used to form smaller articles, such as electronic device displays, optical components, semiconductor devices, or the like, by cutting the thin substrates into the smaller articles via a mechanical or a laser score and break processes. The edges of the glass sheets, glass wafers, and/or the like, if left unfinished before downstream processes such as transportation, scoring and breaking, and/or the like, can have low impact strength and may be susceptible to breakage.

Certain methods for edge finishing can result in undesirable particle generation during material removal, constant particle release from the edge, and a high cost for creating quality edges. Other methods for edge finishing can result in tensile residual stress, which can be rectified by annealing the article for several hours. However, such methods that incorporate a lengthy annealing process are not suitable for high throughput manufacturing.

Accordingly, a need exists for methods of forming articles having a finished edge exhibiting compressive stress, minimal or no tensile stress, and/or little or no flaws, defects, particles, and/or the like that are suitable for high throughput manufacturing processes.

### SUMMARY

In an embodiment, a method of forming a glass-based article having at least one finished edge includes heating a substrate to a preparation temperature, the substrate having at least one unfinished edge, applying a laser to the at least one unfinished edge of the substrate, the laser causing a temperature of the at least one unfinished edge to increase from the preparation temperature to a finishing temperature, and reducing a power of the laser over a time period of at least about 10 seconds until the laser is deactivated, resulting in the glass article comprising the at least one finished edge.

In another embodiment, a method of forming an article having at least one finished edge includes heating a substrate such that the substrate has an average surface temperature from about 450° C. to about 800° C., the substrate having at least one unfinished edge, focusing a laser on the at least one unfinished edge of the substrate to remove at least one defect present in the at least one unfinished edge and causing the average surface temperature of the at least one unfinished edge to increase to about 1300° C., and reducing a power of the laser to zero power, resulting in the article comprising the at least one finished edge.

In another embodiment, a method of forming a plurality of glass articles, each one of the plurality of glass articles having at least one finished edge that exhibits compressive stress, the method including scoring and breaking a glass sheet to obtain a plurality of sections having at least one unfinished edge, and for each section of the plurality of sections, heating the section such that the section has an average surface temperature from about 450° C. to about 800° C., focusing a laser on the at least one unfinished edge of the section to remove defects present in the at least one unfinished edge and causing the average surface temperature of the at least one unfinished edge to rise to about 1300° C., reducing a power of the laser to zero power over a time period of at least about 10 seconds, and allowing the section to cool, resulting in a glass article comprising at least one finished edge that exhibits compressive stress.

In another embodiment, a system for forming a glass-based article that has at least one finished edge includes a laser emitting device, a heating component, a thermal imaging device, and a computing device that is communicatively coupled to the laser emitting device, the heating component, and the thermal imaging device. The computing device is configured to direct the heating component to heat a substrate having one unfinished edge, receive first image data from the thermal imaging device that indicates that an average surface temperature of the substrate is about 450° C. to about 800° C., direct the laser emitting device to apply a laser to the at least one unfinished edge of the substrate, the laser causing an average temperature of the unfinished edge of the substrate to increase to about 1300° C., receive second image data from the thermal imaging device that indicates that an average surface temperature of the at least one unfinished edge is about 1300° C., and direct the laser emitting device to reduce a power of the laser over a time period of at least about 10 seconds until the laser is deactivated, resulting in the glass-based article comprising the at least one finished edge.

In another embodiment, a method of forming a glass article having at least one finished edge includes heating a substrate to a preparation temperature that is greater than a strain point of a glass composition of the substrate, where the substrate has at least one unfinished edge. The method further includes applying a laser to the at least one unfinished edge of the substrate, the laser causing a temperature of the at least one unfinished edge to increase from the preparation temperature to a finishing temperature, and reducing a power of the laser over a time period of at least about 10 seconds until the laser is deactivated, resulting in the glass article having the at least one finished edge.

Additional features and advantages of the methods for forming articles having at least one edge exhibiting compressive stress will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The embodiments set forth in the drawings are illustrative and exemplary in nature and are not intended to limit the subject matter defined by the claims. The following detailed description of the illustrative embodiments can be understood when read in conjunction with the following drawings, where like structure is indicated with like reference numerals and in which:

FIG. 1A schematically depicts an illustrative thin substrate according to one or more embodiments shown and described herein;

FIG. 1B schematically depicts an illustrative thin substrate divided into a plurality of sections according to one or more embodiments shown and described herein;

FIG. 2A schematically depicts a cross-sectional view of an article having a chamfered finish according to one or more embodiments shown and described herein;

FIG. 2B schematically depicts a cross-sectional view of an article having an R-edge finish according to one or more embodiments shown and described herein;

FIG. 2C schematically depicts a cross-sectional view of an article having a bull nose finish according to one or more embodiments shown and described herein;

FIG. 3 schematically depicts a side view of an illustrative finishing system for forming an article having an edge with compressive residual stress according to one or more embodiments shown and described herein;

FIG. 4 schematically depicts a detailed view of an illustrative finishing system that produces a sweeping laser beam according to one or more embodiments shown and described herein;

FIG. 5 depicts a flow diagram of an illustrative method of finishing edges of an article according to one or more embodiments shown and described herein;

FIG. 6A depicts a cross-sectional view of an edge of a finished article formed from a process of finishing edges according to one or more embodiments shown and described herein;

FIG. 6B depicts a side view of an edge of a finished article formed from a process of finishing edges according to one or more embodiments shown and described herein;

FIG. 7 graphically depicts an illustrative temperature history of an article formed from a process of finishing edges according to one or more embodiments shown and described herein;

FIG. 8 graphically depicts residual stress in an edge of an article with respect to a selected preheating temperature according to one or more embodiments shown and described herein;

FIG. 9 graphically depicts illustrative residual stress on an edge of an article formed from a process of finishing edges according to one or more embodiments shown and described herein;

FIG. 10A depicts a strainoscope image of a first major surface of an illustrative article formed from a process of finishing edges according to one or more embodiments shown and described herein; and

FIG. 10B depicts a strainoscope image of a second major surface of an illustrative article formed from a process of finishing edges according to one or more embodiments shown and described herein.

### DETAILED DESCRIPTION

Referring generally to the figures, embodiments of the present disclosure are generally related to articles having one or more finished edges exhibiting an amount of compressive stress, minimal or no tensile stress, and/or minimal or no flaws, defects, particles, or the like, particularly those articles that are formed via high throughput manufacturing. Such manufacturing may include forming larger substrate sheets, wafers, and/or the like that are subsequently divided into the smaller articles after the edges are finished and/or prior to finishing the edges. Division of such sheets may occur via a score and break procedure or other similar procedure to section the substrate sheets into a plurality of sections. Such articles may include, but are not limited to, electronic device display screens, such as smartphone screens, tablet screens, personal computer displays, television screens, or the like, optical components such as lenses or the like, semiconductor devices, and/or the like.

More particularly, embodiments described herein are directed to glass-based articles having one or more edges formed by a laser-based thermal finishing process that includes preheating the articles to a particular temperature, completing a laser finishing process on the edges of the articles, gradually reducing the laser power to cool the edges, and allowing the articles to cool to room temperature. Edges having particular characteristics formed via the methods described herein may increase the reliability of downstream processes, such as micro-device manufacturing processes, TFT panel manufacturing, or the like. Furthermore, the processes described herein do not require an annealing step that takes several hours to complete, which hinders the ability to form the article using high throughput manufacturing processes.

Edges of articles, particularly glass articles such as glass substrates, can be finished via a mechanical process or via a laser based process. Mechanical processes for finishing glass articles may include mechanical grinding and polishing. However, such mechanical processes generate particles during material removal, constantly release particles from the edge to other parts of the article even after cleaning, and can be costly and time-consuming to create high-quality edges (e.g., edges that are suitable for electronic device display screens or the like). Laser based processes for finishing glass articles may be more desirable than mechanical finishing in some instances, particularly where it is necessary to ensure minimal or no defects in the edges and/or to avoid a release of particles. However, applying a laser to the edges causes the temperature of the glass to increase, which, upon cooling, can result in tensile residual stress, which can lead to cracking and other damage. One solution to avoid tensile residual stress involves an annealing process. However, such annealing processes can take hours to complete, which may make such processes undesirable in high-throughput manufacturing where waiting for hours is not feasible or desirable.

As used herein, “compressive stress” refers to a stress profile parameter that provides an estimate of the surface compression of the article. This parameter may correlate with an amount of stress that needs to be applied to cause a failure of a glass article, particularly when the glass is free of substantially deep mechanical flaws. An article exhibiting compressive stress or exhibiting an amount of compressive stress as used herein refers to any measurable amount of compressive stress that is greater than 0 megapascals (MPa). In particular embodiments, an article may exhibit compressive stress that is about 10 MPa to about 80 MPa, including about 10 MPa, about 20 MPa, about 30 MPa, about 40 MPa, about 50 MPa, about 60 MPa, about 70 MPa, about 80 MPa, or any value or range between any two of these values (including endpoints).

Various embodiments of articles having at least one finished edge, methods of forming articles having at least one finished edge, and systems for forming articles having at least one finished edge are described in detail below.

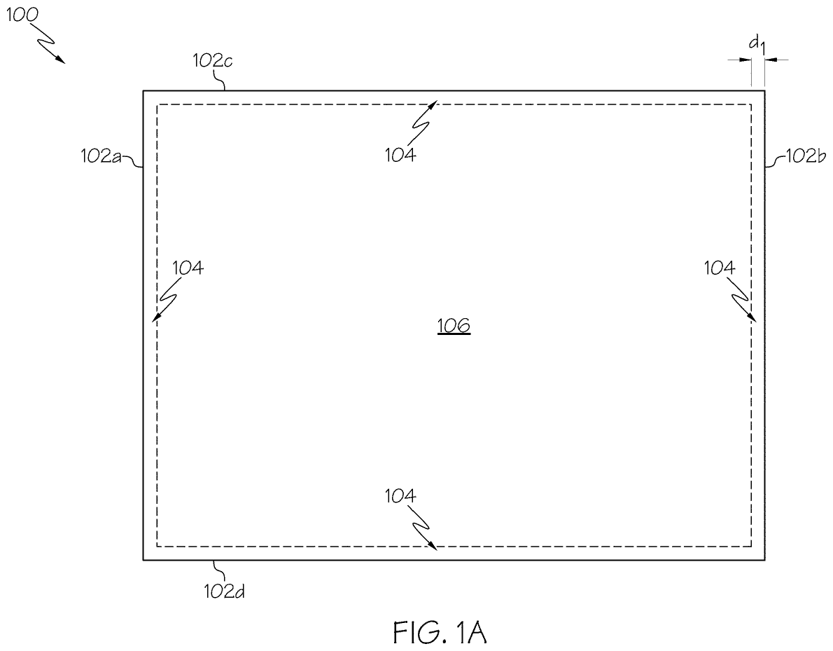

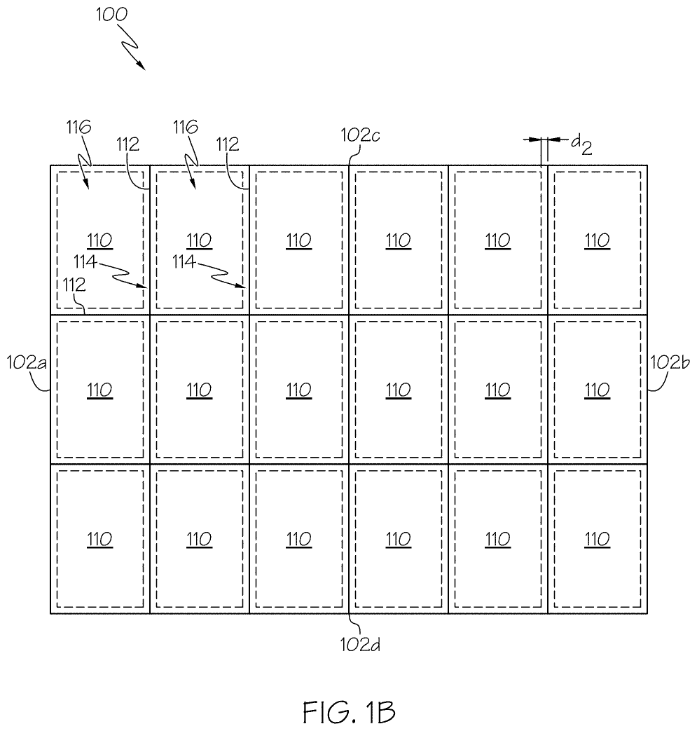

FIG. 1A depicts an illustrative example of a thin substrate, such as a glass sheet or the like. More specifically, FIG. 1A depicts a glass sheet 100 having a first sheet edge 102a, a second sheet edge 102b, a third sheet edge 102c, and a fourth sheet edge 102d (collectively referred to as sheet edges 102). The glass sheet 100 may define at least one edge region 104 located radially outward from a central portion 106 thereof. The glass sheet 100 depicted with respect to FIG. 1A is generally a substrate that is later sectioned in downstream processes to obtain certain glass articles (e.g., TFT substrates). However, it should be understood that the glass sheet 100 may also be a wafer that is later sectioned in downstream processes to obtain certain glass articles (e.g., glass chips). It should also be understood that the glass sheet 100 may be any other glass substrate (including full sheets, wafers, finished goods, and/or the like), and that the use of the term “glass sheet” herein is not limited to any particular type of glass substrate.

The shape and/or size of the glass sheet 100 is not limited by this disclosure, and may generally be any shape or size. In the embodiment depicted in FIG. 1A, the glass sheet 100 may generally be a flat substrate that is quadrangular in shape (e.g., having the four sheet edges 102). However, other shapes are contemplated and included within the scope of the present disclosure. In some embodiments, the glass sheet 100 may be a substrate having a cross sectional thickness that remains constant when traversing the glass sheet 100 from the first sheet edge 102a to the second sheet edge 102b and when traversing the glass sheet 100 from the third sheet edge 102c to the fourth sheet edge 102d. In other embodiments, the glass sheet 100 may be a substrate having a cross sectional thickness that varies when traversing the glass sheet 100 from the first sheet edge 102a to the second sheet edge 102b and/or when traversing the glass sheet 100 from the third sheet edge 102c to the fourth sheet edge 102d.

The glass sheet 100 may generally be formed via any method of forming glass sheets now known or later developed. For example, the glass sheet 100 may be formed via a fusion drawn manufacturing process. In embodiments, the glass sheet 100 may be formed using any glass composition suitable for producing glass sheets. For example, the glass sheet 100 may be formed of aluminosilicate, borosilicate, combinations thereof, or the like. An illustrative example glass sheet may be an alkaline earth boro-aluminosilicate glass, such as Lotus™ NXT glass or EAGLE XG® Slim Glass, both of which are manufactured by Corning, Inc. (Corning, N.Y.).

The at least one edge region 104 of the glass sheet 100 may generally correspond to an area or region of the glass sheet 100 that is adjacent to one of the sheet edges 102. That is, one of the sheet edges 102 may define each of the edge regions 104 of the glass sheet 100. In some embodiments, each edge region 104 may be a region of the glass sheet 100 that is adjacent to one of the sheet edges 102, as indicated by the dashed lines in FIG. 1A. That is, each of the edge regions 104 may extend a distance d₁ from one of the sheet edges 102. In some embodiments, the distance d₁ may be from about 1 millimeter (mm) to about 10 mm, including about 1 mm, about 2 mm, about 3 mm, about 4 mm, about 5 mm, about 6 mm, about 7 mm, about 8 mm, about 9 mm, about 10 mm, or any value or range between any two of these values (including endpoints). In some embodiments, each edge region 104 of the glass sheet 100 may be the sheet edges 102 themselves. In such embodiments, the distance d₁ may be zero. As such, the edge regions 104 may also be referred to as an edge herein. In some embodiments, at least a portion of one or more of the edge regions 104 may be unfinished as a result of sheet formation and/or a score and break process, and thus may be referred to herein as an unfinished edge prior to completion of the processes described herein. As a result of the processes described in greater herein, the edge regions 104 of the glass sheet 100 may be finished to exhibit few or no defects, flaws, particles, and/or the like, to exhibit little or no tensile stress, and/or to exhibit an amount of compressive stress. Accordingly, after completion of the processes described herein, each edge region 104 may be referred to as a finished edge.

The central portion 106 of the glass sheet 100 may generally be a portion that is bounded on one or more sides by one or more of the sheet edges 102. In the embodiment depicted in FIG. 1A, the central portion 106 of the glass sheet 100 is bounded on four sides by the edge regions 104 such that edge regions 104 completely surround the central portion 106. In some embodiments, the central portion 106 of the glass sheet 100 may contain little or no defects as a result of a glass sheet forming process. It should be understood that defects within glass include bubbles, impurities, foreign particles, stressed portions, cracks, scratches, and/or the like.

Referring now to FIG. 1B, the glass sheet 100 may be dividable into a plurality of sections 110. More particularly, the glass sheet 100 is dividable into a plurality of sections 110 that are defined by a plurality of score lines 112 and/or the one or more of the sheet edges 102. Each of the plurality of sections 110 may have at least one section edge region 114 located radially outward from a central portion 116 thereof.

The at least one section edge region 114 of each of the plurality of sections 110 of the glass sheet 100 may generally correspond to an area or region of each of the plurality of sections 110 that is adjacent to a score line 112 or adjacent to a sheet edge 102. That is, the score lines 112 or one of the sheet edges 102 may define each of the section edge regions 114 of the one or more sections 110. In some embodiments, each section edge region 114 may be a region of a respective section 110 that is adjacent to a score line 112 or a sheet edge 102, as indicated by the dashed lines in FIG. 1B. That is, each of the section edge regions 114 may extend a distance d₂ from a score line 112 or a sheet edge 102. In some embodiments, the distance d₂ may be from about 1 millimeter (mm) to about 10 mm, including about 1 mm, about 2 mm, about 3 mm, about 4 mm, about 5 mm, about 6 mm, about 7 mm, about 8 mm, about 9 mm, about 10 mm, or any value or range between any two of these values (including endpoints). In some embodiments, each section edge region 114 may be the sheet edges 102 and/or the score lines 112 themselves. In such embodiments, the distance d₂ may be zero. As such, the section edge regions 114, like the edge regions 104, may be referred to as an edge herein. In some embodiments, at least a portion of the area encompassed by the section edge regions 114 may be unfinished as a result of sheet formation and/or a score and break process, and similar to the edge regions 104 described with respect to FIG. 1A, may also be referred to as an unfinished edge prior to completion of the processes described herein. Similarly, as a result of the processes described in greater herein, the section edge regions 114 may be finished to exhibit few or no defects, flaws, particles, and/or the like, to exhibit little or no tensile stress, and/or to exhibit an amount of compressive stress. Accordingly, after completion of the processes described herein, each section edge region 114, like the edge regions 104 described with respect to FIG. 1A, may also be referred to as a finished edge.

Still referring to FIG. 1B, the central portion 116 of each of the plurality of sections 110 may generally be a portion that is bounded on one or more sides by an section edge region 114. In the embodiment depicted in FIG. 1B, the central portion 116 of each of the plurality of sections 110 is bounded on four sides by the section edge regions 114 of each of the plurality of sections 110 such that the section edge regions 114 completely surround the central portion 116. In some embodiments, the central portion 116 of each of the sections 110 may contain little or no defects as a result of a glass sheet forming process. It should be understood that defects within glass include bubbles, impurities, foreign particles, stressed portions, cracks, scratches, and/or the like.

While FIG. 1B depicts the glass sheet 100 divided into a plurality of substantially equal sized sections 110 (e.g., a grid configuration having eighteen sections 110), this is merely illustrative. That is, the glass sheet 100 may be scored and sectioned in any number of different ways to produce any number and size sections 110 therefrom. In some embodiments, all of the sections 110 may be substantially equal in size and dimensions. In other embodiments, at least a first portion of the sections 110 may be differently sized and dimensioned relative to a second portion of the sections 110. That is, one or more sections 110 may be differently sized and shaped relative to one or more other sections on the same glass sheet 100. In some embodiments, the entire glass sheet 100 may be used for the various sections 110 (e.g., glass remains after scoring and breaking the sections 110). In other embodiments, only a portion of the glass sheet 100 may be used for the various sections 110 (e.g., a portion of the glass sheet 100 may not be used and/or may be discarded).

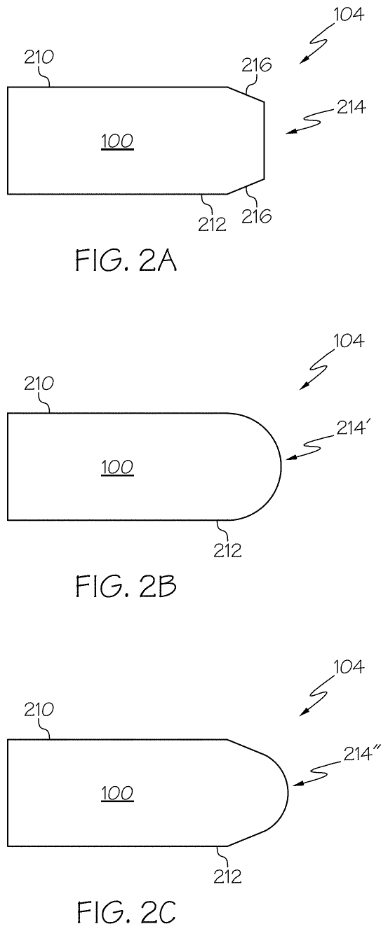

Referring to FIGS. 1A and 1B, at least one edge region 104 of the glass sheet 100 (FIG. 1A) and/or section edge region 114 of each section 110 (FIG. 1B) may be finished such that it has a particular shape and/or exhibits particular qualities such as a presence of defects (or lack thereof), a presence of compressive stress, a lack of tensile stress, and/or the like. Illustrative shapes of the at least one edge region 104 of the glass sheet 100 are depicted in FIGS. 2A-2C. More specifically, FIG. 2A depicts a cross sectional view of a glass sheet 100 having an edge region 104 with a chamfered finish, FIG. 2B depicts a cross sectional view of a glass sheet 100 having an edge region 104 with an R-edge finish, and FIG. 2C depicts a cross sectional view of a glass sheet 100 having an edge region 104 with a bull nose finish. That is, the edge region 104 is a finished edge in a chamfered shape (FIG. 2A), an R-edge shape (FIG. 2B), a bull nose shape (FIG. 2C), or the like. It should be understood that the various edge surface finishes depicted in FIGS. 2A-2C are merely illustrative, and other edge surface finishes are contemplated and included within the scope of the present disclosure. It should be understood that while the edge regions 104 of the glass sheet 100 are depicted in FIGS. 2A-2C, similar finishes can be achieved with the section edge regions 114 of each section 110 of the glass sheet 100 (FIG. 1B). As such, the description below with respect to FIGS. 2A-2C is applicable to both the glass sheet 100 and each individual section 110 thereof.

As shown in FIG. 2A, the glass sheet 100 includes a first major surface 210 (e.g., an upper surface) and a second major surface 212 (e.g., a lower surface) spaced a distance from the first major surface 210. As also shown in the embodiment depicted in FIG. 2A, the first major surface 210 and the second major surface 212 are substantially parallel to one another. However, non-parallel configurations of the first major surface 210 and the second major surface 212 are contemplated. An edge surface 214 that is substantially normal to the first major surface 210 and the second major surface 212 extends between the first major surface 210 and the second major surface 212 via beveled edges 216 that are angled between the first major surface 210 and the edge surface 214 and between the second major surface 210 and the edge surface 214. In some embodiments, the beveled edges 216 may be about 45° relative to the respective major surface 210, 212 and/or the edge surface 214. However, other angles are contemplated and included within the scope of the present disclosure.

As shown in FIGS. 2B and 2C, the glass sheet 100 includes the first major surface 210 and the second major surface 212 spaced a distance from the first major surface 210. As also shown in the embodiment depicted in FIG. 2B, the first major surface 210 and the second major surface 212 are substantially parallel to one another. However, non-parallel configurations of the first major surface 210 and the second major surface 212 are contemplated. A rounded edge surface may provide a transition between the first major surface 210 and the second major surface 212, such as edge surface 214′ depicted in FIG. 2B and edge surface 214″ depicted in FIG. 2C.

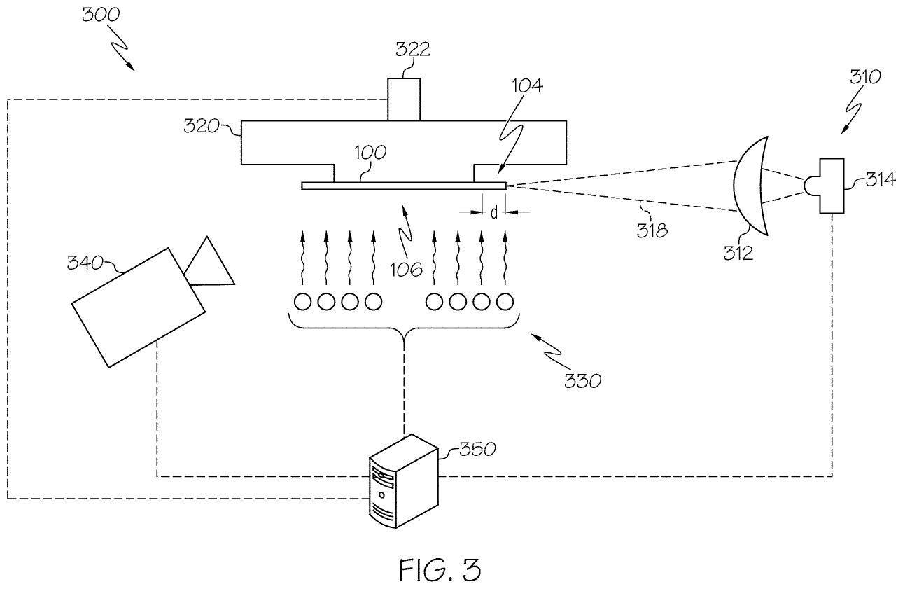

To obtain the edges depicted in FIGS. 2A-2C, as well as other shaped edges not depicted, a laser-based finishing system may be used. FIG. 3 depicts an illustrative example of a finishing system 300 that may be used to form the finished edges of the glass sheet 100 (or the finished edges of a section of the glass sheet 100). The finishing system 300 generally includes at least a laser emitting device 310 and a heating component 330. In some embodiments, the finishing system 300 may further include a support 320, an imaging device 340, and/or a computing device 350.

The laser emitting device 310 is generally a device that emits a laser that can be particularly aimed and focused at a target area (such as the edge region 104 of the glass sheet 100). That is, the laser emitting device 310 may include an emitter 314 that emits light at a particular frequency and/or wavelength to cause the edge region 104 of the glass sheet 100 to increase in temperature, a change in viscosity, and/or the like, as described herein. In some embodiments, the laser emitting device 310 may emit a gas laser. That is, the emitter 314 discharges an electric current through a gas to produce coherent light that is aimed and focused on the edge region 104 of the glass sheet 100. The gas is not limited by the present disclosure, and may generally be any gas that is suitable for producing coherent light. An illustrative example is carbon dioxide (CO₂) gas. That is, the emitter 314 may be referred to as a CO₂ emitter that emits a CO₂ laser beam.

In some embodiments, the laser emitting device 310 may further include a lens 312 arranged to focus the light emitted by the emitter 314. The lens 312 may generally be coupled to or arranged adjacent to the emitter 314 such that a focused laser beam 318 propagated through the lens 312 is aimed at the edge region 104 of the glass sheet 100 to heat the edge region 104, as described herein.

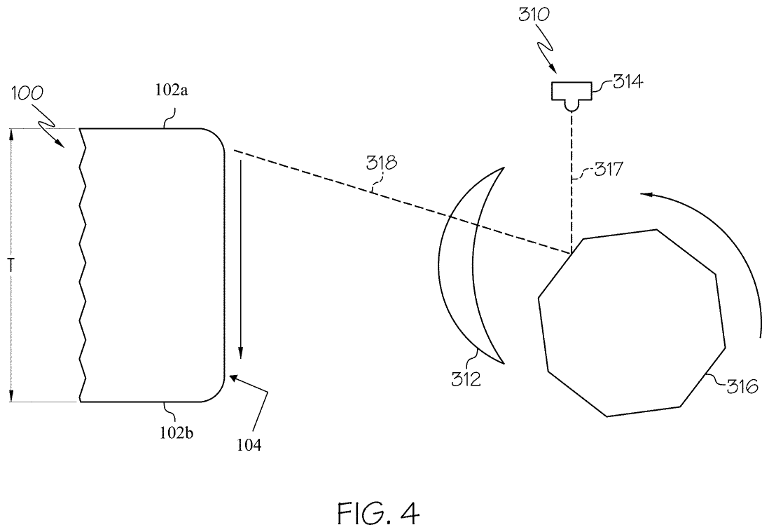

Referring to FIG. 4, the laser emitting device 310 may further include one or more components that allow the focused laser beam 318 to move in some embodiments. That is, the laser emitting device 310 may cause the focused laser beam 318 to oscillate in some embodiments. For example, the laser emitting device 310 may include a moving reflective surface 316 positioned between the emitter 314 and the edge region 104 of the glass sheet 100. In some embodiments, the moving reflective surface 316 may be positioned between the emitter 314 and the lens 312. As the moving reflective surface 316 moves (e.g., rotates in a counter-clockwise direction etc.), unfocused light 317 from the emitter 314 incident on the moving reflective surface 316 may be directed by the moving reflective surface 316 to a particular portion of the edge region 104 such that the focused laser beam 318 moves in accordance with the movement of the moving reflective surface 316. Thus, as the moving reflective surface 316 continues to move, the focused laser beam 318 moves accordingly (as indicated by the downward facing arrow of FIG. 4).

The moving reflective surface 316 may be a mirror, an array of mirrors, a prism, a lens, and/or the like. In addition, the moving reflective surface 316 may have any shape or size, particularly shapes and sizes that correspond to the size of the edge region 104, the distance between the moving reflective surface 316 and the edge region 104, and/or the like. In addition, the moving reflective surface 316 may move in any manner and at any speed, particularly manners and speeds that produce an oscillating focused laser beam 318. For example, the moving reflective surface 316 depicted in the embodiment in FIG. 4 may be an octagonal shaped component having eight mirrored surfaces, the octagonal shaped component rotating in a counter-clockwise direction at a particular rotational speed such that the focused laser beam 318 traverses a distance from the first edge 102a to the second edge 102b of the glass sheet 100 when the unfocused light 317 from the emitter 314 is incident on a particular moving reflective surface 316 causes the focused laser beam 318 to move down from the first edge 102a to the second edge 102b, as indicated by the arrow in FIG. 4. When the rotation of the octagonal shaped component causes the unfocused light 317 from the emitter 314 to be incident on another mirrored surface, the focused laser beam 318 may return to the portion of the edge region 104 adjacent to the first edge 102a of the glass sheet 100 to repeat the movement. As a result, the focused laser beam 318 oscillates along the edge region 104 between the first edge 102a and the second edge 102b at a particular frequency that corresponds to the rotational speed of the moving reflective surface 316. For example, the focused laser beam 318 may oscillate between the first edge 102a and the second edge 102b at a frequency of about 100 Hertz (Hz) to about 2 kilohertz (kHz), including about 100 Hz, about 200 Hz, about 300 Hz, about 400 Hz, about 500 Hz, about 600 Hz, about 700 Hz, about 800 Hz, about 900 Hz, about 1 kHz, about 1.1 kHz, about 1.2 kHz, about 1.3 kHz, about 1.4 kHz, about 1.5 kHz, about 1.6 kHz, about 1.7 kHz, about 1.8 kHz, about 1.9 kHz, about 2 kHz, or any value or range between any two of these values (including endpoints). In particular embodiments, the focused laser beam 318 may oscillate between the first edge 102a and the second edge 102b at a frequency of about 1 kHz.

Referring again to FIG. 3, the heating component 330 may generally be any device or component that provides heat to increase the temperature of the glass sheet 100, particularly the central portion 106 thereof. In the embodiment depicted in FIG. 3, the heating component 330 may be a plurality of infrared heaters, such as an array of infrared heaters. In other embodiments, the heating component 330 may be a heated platform, a kiln, a lehr, or the like that provides a heated environment such that, when the glass sheet 100 is placed therein or thereon, the glass sheet 100 heats to a particular temperature (e.g., a preparation temperature).

In some embodiments, the finishing system 300 may further include the support 320, such as a heated vacuum chuck, a support surface, a support substrate, and/or the like. In the embodiment depicted in FIG. 3, the support 320 is a heated vacuum chuck that holds the glass sheet 100 in place via suction and further heats the glass sheet 100 (e.g., the central portion 106 thereof) to a particular temperature (e.g., a preparation temperature), as described herein. Heated vacuum chucks should generally be understood and are not described in greater detail herein. In embodiments where the support 320 is a heated vacuum chuck, the support 320 may alone heat the glass sheet 100 or may function in conjunction with the heating component 330 to heat the glass sheet 100. For example, the glass sheet 100 may be held by the support 320 between heated components of the support 320 (not shown) and the heating component 330 to heat the glass sheet 100 to a particular temperature and/or to maintain the temperature of the glass sheet 100.

In some embodiments, the support 320 may be coupled to a component that moves and/or holds the support 320. For example, the support 320 may be coupled to a robot arm 322. That is, the robot arm 322 may be coupled to the support 320 and may further be configured to move the support 320 relative to various other components of the finishing system 300, such as, for example, the laser emitting device 310 and/or the heating component 330. For example, the robot arm 322 may be configured to move the support 320 to a glass sheet 100 to be finished such that the glass sheet 100 is collected by the support, then move the glass sheet 100 to an area containing the laser emitting device 310 and the heating component 330 for finishing.

The support 320 may generally be positioned at any distance from the laser emitting device 310, particularly a distance that allows for the focused beam 318 to be received on the edge region 104 of the glass sheet 100. In some embodiments, the distance may be selected based on the shape and/or size of the lens 312, the distance between the laser emitting device 310 and the lens 312, the characteristics of the light output by the laser emitting device 310, and/or the like.

In some embodiments, the finishing system 300 may further include the imaging device 340, which is arranged to obtain image data relating to the glass sheet 100 or a portion thereof, including the central portion 106 thereof and/or the edge region 104 thereof and transmit the image data accordingly. In some embodiments, the imaging device 340 may be a thermal imaging device that collects thermal image data, such as a thermal camera or the like. In some embodiments, the imaging device 340 may continuously obtain image data (e.g., video). In other embodiments, the imaging device 340 may only obtain image data at particular intervals.

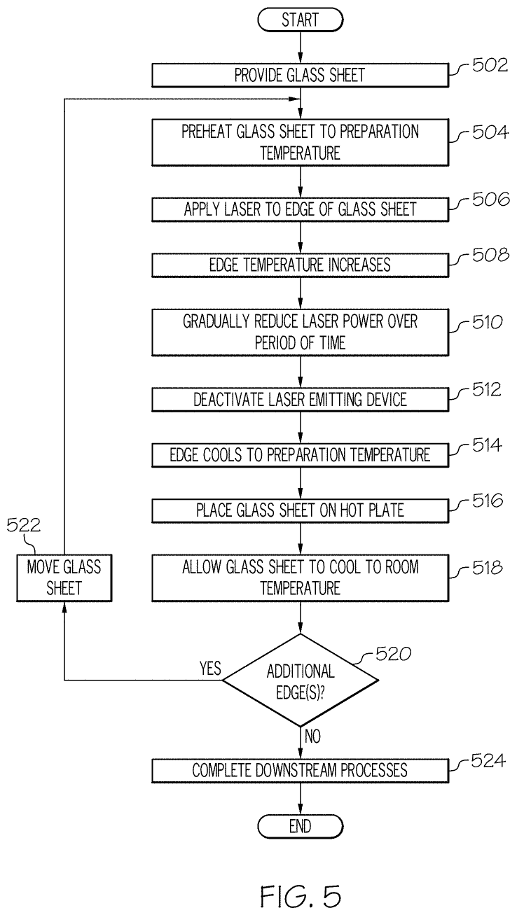

The finishing system 300 may also include the computing device 350 in some embodiments. The computing device 350 may generally contain a processor and a non-transitory, processor-readable storage medium containing instructions thereon for executing a set of processes, such as one or more of the steps described with respect to FIG. 5. The computing device 350 may further be communicatively coupled to one or more of the laser emitting device 310, the robot arm 322, the heating component 330, and the imaging device 340. In operation, the computing device 350 may receive image data from the imaging device 340, direct a display (not shown) to display images corresponding to the received image data, determine and generate signals for transmitting to the robot arm 322 to cause the robot arm 322 to move, determine and generate signals for transmitting to the heating component 330 to cause the heating component to increase or decrease a temperature, and/or determine and generate signals for transmitting to the laser emitting device 310 to cause the laser emitting device 310 to adjust characteristics of the light emitted therefrom (e.g., power), to turn off, to turn on, and/or the like. For example, the computing device 350 may be configured to receive image data from the imaging device 340, determine a temperature of the glass sheet 100 and/or a portion thereof (including a temperature of the central portion 106, a temperature of the edge region 104, and/or a temperature of one or more sections 110 (FIG. 1B)) from the image data, determine whether the heating component 330 and/or the laser emitting device 310 need to be adjusted accordingly, and if so, transmit a corresponding signal to the heating component 330 and/or the laser emitting device 310.

Still referring to FIG. 3, it should be understood that the computing device 350 may be omitted in some embodiments. In such embodiments, the imaging device 340 may include a display (not shown) coupled thereto such that images corresponding to the obtained image data can be viewed by a user. For example, a user may manually adjust the various components of the finishing system 300 in accordance with information received via the display coupled to the imaging device 340, as described herein.

FIG. 5 depicts an illustrative method of finishing edges of an article according to various embodiments. Referring now to FIGS. 1A and 5, the glass sheet 100 may be provided at block 502. That is, the glass sheet 100 may be received from a sheet manufacturer or may be formed according to any glass sheet formation process now known or later developed. The glass sheet 100 may have at least one unfinished edge. For example, at least one of the edge regions 104 may be an unfinished edge.

Referring now to FIGS. 1A, 3, and 5, the glass sheet 100 may be preheated at block 504. More specifically, the glass sheet 100 may be heated to a preparation temperature by placing the glass sheet 100 on a heated platform, in a kiln, a lehr, or the like, placing the section adjacent to one or more infrared heaters, and/or by heating the support 320 (e.g., a heated vacuum chuck) that is holding the glass sheet 100, as described herein. The glass sheet 100 may generally be heated until an average surface temperature of the glass sheet 100 as indicated by the imaging device 340 is at the preparation temperature. In addition, heating may further be used to maintain the average surface temperature of the glass sheet 100 at the preparation temperature for a period of time. For example, the average surface temperature of the glass sheet 100 may be maintained at the preparation temperature at least until the laser is applied to the at least one unfinished edge of the glass sheet 100, as described herein.

The preparation temperature may generally be a temperature at which the glass sheet 100 will not shatter upon application of a laser to the edges thereof due to a high thermal gradient between the edge regions 104 and the central portion 106 thereof. For example, preheating the glass sheet 100 such that the average surface temperature of the glass sheet 100 is less than about 450° C. may cause the section to shatter due to a high thermal gradient when the laser is applied in some embodiments. In some embodiments, the preparation temperature may be less than a softening point of the glass composition used for the glass sheet 100. In some embodiments, the preparation temperature may be greater than an annealing temperature of the glass composition used for the glass sheet 100. As such, the preparation temperature may vary depending on the glass composition, characteristics of the glass (e.g., glass viscosity), additives within the glass, type of laser used, and/or the like. In some embodiments, the preparation temperature may be from about 450° C. to about 800° C. For example, the preparation temperature may be about 450° C., about 500° C., about 550° C., about 600° C., about 650° C., about 700° C., about 750° C., about 800° C., or any value or range between any two of these values (including endpoints). In some embodiments, the preparation temperature may be a temperature that is greater than a strain point of the glass composition used for the glass sheet 100. As used herein, the term “strain point” refers to a temperature below which permanent strain cannot be introduced into the glass. It should generally be understood that different glass compositions may have different strain points. One illustrative glass composition, EAGLE XG® Slim Glass (Corning, Inc., Corning, N.Y.) has a strain point of 669 at 10^{14.5} poises, which means the glass composition reaches a viscosity of 10^{14.5} poises at 669° C. As such, when using the above-mentioned glass composition as the glass sheet 100, the preparation temperature may be 669° C. Another illustrative glass composition, Lotus NXT Glass (Corning, Inc., Corning, N.Y.) has a strain point of 752 at 10^{14.5} poises, which means the glass composition reaches a viscosity of 10^{14.5} poises at 752° C. As such, when using the above-mentioned glass composition as the glass sheet 100, the preparation temperature may be 752° C.

Referring to FIGS. 3 and 5, to ensure that the glass sheet 100 is appropriately preheated to the preparation temperature, the imaging device 340 may be used to measure the temperature of the glass sheet 100. That is, the imaging device 340 may receive thermal image data and provide thermal images via a display, which is then used to determine whether the glass sheet 100 and/or a portion thereof has reached the preparation temperature. In some embodiments, image data captured by the imaging device 340 may be transmitted to the computing device 350, which determines whether the glass sheet 100 has reached the preparation temperature from the data and executes one or more processes accordingly.

Referring now to FIGS. 3-5, once the glass sheet 100 has been preheated to the preparation temperature, the focused laser beam 318 may be applied to the at least one unfinished edge of the glass sheet 100 at block 506. This may be completed, for example, by aligning the at least one unfinished edge with respect to the laser emitting device 310 such that the focused laser beam 318 emitted by the emitter 314 through the lens 312 (and optionally incident on the moving reflective surface 316) is directed at least a portion of the edge region 104. Aligning the at least one unfinished edge may include moving one or more of the laser emitting device 310 (or a component thereof), the robot arm 322, and the support 320. For example, the robot arm 322 may be manually controlled via a user interface to align the at least one unfinished edge with the focused laser beam 318. In another example, the robot arm 322 and/or the laser emitting device 310 (or component thereof) may be preprogrammed to move in a particular manner at a particular time. In another example, the robot arm 322 and/or the laser emitting device 310 (or a component thereof) may be directed to move by the computing device 350. That is, the computing device 350 may transmit one or more signals to the robot arm 322 and/or the laser emitting device 310 (or a component thereof) to cause the robot arm 322 and/or the laser emitting device 310 (or a component thereof) to move accordingly. In addition to moving, the laser emitting device 310 may be activated to emit the focused laser beam 318. That is, the laser emitting device 310 may be manually switched on or may receive a signal from the computing device 350 to activate.

In some embodiments, applying the focused laser beam 318 may include directing the emitter 314 to operate at a particular power so as to appropriately complete the finishing process on the edge region 104 of the glass sheet 100. In some embodiments, the emitter 314 may be directed to operate at full power. In other embodiments, the emitter 314 may be directed to operate at less than full power. The amount of power at which the emitter 314 is operated may be selected based on the desired shape of the edge region 104 in some embodiments.

In some embodiments, applying the focused laser beam 318 to the edge region 104 of the glass sheet 100 may include moving the focused laser beam 318 along an edge region 104. For example, the focused laser beam 318 may move between the first edge 102a and the second edge 102b, as described herein. More specifically, the focused laser beam 318 may oscillate at a particular frequency between the first edge 102a and the second edge 102b, as described herein.

As a result of applying the laser to the unfinished edge of the glass sheet 100, the edge region 104 increases in temperature at block 508. That is, the temperature of the edge region 104 (or average surface temperature of the edge region 104) may rise above the preparation temperature. Such an increase in temperature decreases the viscosity of the glass composition, thereby healing flaws and/or defects and/or removing particles that may be present in the edge region 104. The temperature at which the flaws and/or defects are healed and/or the particles are removed is referred to herein as the finishing temperature. It should be understood that the finishing temperature may vary based on the glass composition, characteristics of the glass (e.g., glass viscosity), additives within the glass, type of laser used, and/or the like. In some embodiments, the finishing temperature may be from about 1000° C. to about 1500° C., including about 1000° C., about 1100° C., about 1200° C., about 1300° C., about 1400° C., about 1500° C., or any value or range between any two of these values (including endpoints). In particular embodiments, the finishing temperature may be about 1300° C. It should also be understood that while the edge region 104 of the glass sheet 100 may heat to the finishing temperature, other portions of the glass sheet 100 (e.g., the central portion 106 of the glass sheet 100 depicted in FIG. 1A) may not rise to the finishing temperature. That is, other portions of the glass sheet 100 may remain at the preparation temperature or at a temperature between the preparation temperature and the finishing temperature.

The process of applying the focused laser beam 318 to the edge region 104 of the glass sheet 100 to heat the edge region 104, shape the edge region 104 such that it exhibits particular shape properties, and heal the flaws and/or defects, and/or remove the particles that are present in the edge region 104 may be completed over any period of time that is necessary and results in a number of flaws, defects, and/or particles that is equal to or less than a threshold number of flaws, defects, and/or particles that is generally acceptable in a finished product. In some embodiments, such an application may take about 1 second to about 10 seconds, including about 1 second, about 2 seconds, about 3 seconds, about 4 seconds, about 5 seconds, about 6 seconds, about 7 seconds, about 8 seconds, about 9 seconds, about 10 seconds, or any value or range between any two of these values (including endpoints).

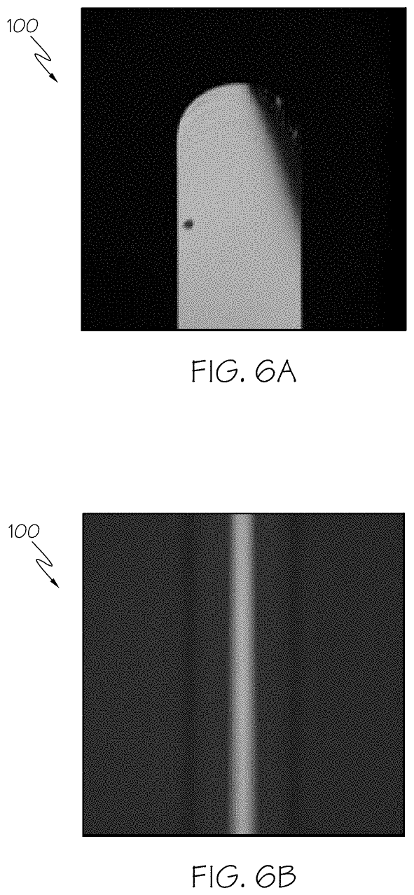

As a result of the processes described herein with respect to blocks 506 and 508, the edge region 104 of the glass sheet 100 may exhibit little or no flaws, defects, or particles. That is, the edge region 104 may have no flaws, particles, and/or defects or may have a number of flaws, particles and/or defects that are at or below a threshold number that is determined to be acceptable for a final product. An illustrative example of the section exhibiting little or no flaws, defects, or particles is depicted in FIGS. 6A and 6B.

Referring again to FIGS. 3-5, once all of the flaws, defects, and/or particles in the at least one edge region 104 have been healed (or less than a threshold number remain in the at least one edge region 104), the power of the laser emitted by the laser emitting device 310 may be gradually reduced over a period of time at block 510 until the laser emitting device 310 is deactivated at block 512. That is, the power supplied to the emitter 314 may be reduced in a stepwise fashion over a particular period of time until the emitter 314 is no longer emitting light (e.g., the laser is at zero power). For example, the power supplied to the emitter 314 may be reduced by a certain percentage after a particular amount of time has elapsed. That is, the amount of power supplied to the emitter 314 may be reduced 10 percent every five seconds until the laser emitting device 310 is deactivated. In another example, the power supplied to the emitter 314 may be continuously reduced over a particular amount of time. That is, the amount of power supplied to the emitter 314 may be continuously reduced over a time period until the laser emitting device 310 is deactivated. In either example, the amount of time the power is gradually reduced may be at least about 10 seconds. For example, the amount of time the laser power is gradually reduced may be about 10 seconds, about 15 seconds, about 20 seconds, about 25 seconds, about 30 seconds, about 35 seconds, about 40 seconds, about 45 seconds, about 50 seconds, about 55 seconds, about 60 seconds, about 65 seconds, about 70 seconds or greater, or any value or range between any two of these values (including endpoints). In particular embodiments, the laser power may be reduced from full power to zero power over a time period of about 30 seconds to about 60 seconds.

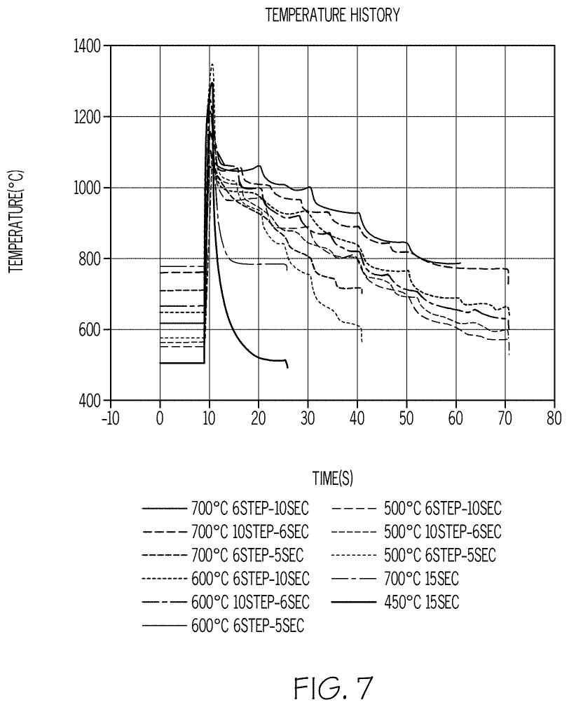

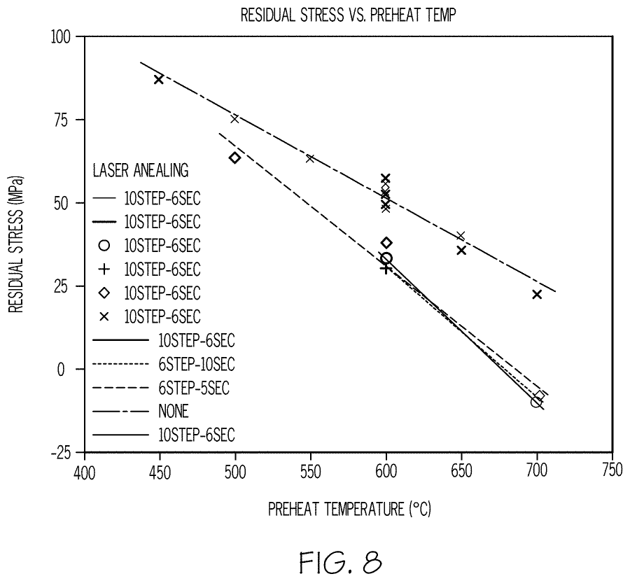

As a result of this gradual reduction of laser power over a period of time until the laser is deactivated according to blocks 510 and 512, the edge region 104 of the glass sheet 100 cools at block 514. For example, FIG. 7 depicts various cooling temperatures achieved for a particular glass composition as a result of a gradual reduction of laser power over a period of time. As indicated in FIG. 7, the edge region 104 may increase to about 1300° C. and may then decrease back to the preparation temperature as a gradual power reduction of the laser is applied. At this point, the glass sheet 100 may be referred to as a glass based article having at least one finished edge.

In addition, the combination of preheating the glass sheet 100 to the preparation temperature according to block 504 and gradually reducing the laser power and deactivating the laser emitting device 310 according to blocks 510 and 512 results in the finished edges (e.g., finished edge regions 104) having less tensile residual stress relative to other laser finishing processes when measured by strainoscope and retardation, as depicted in FIG. 8.

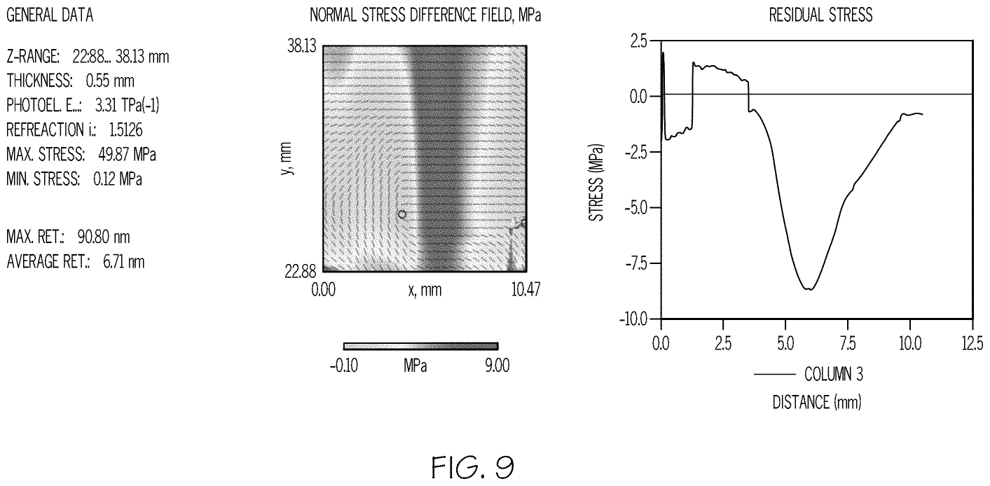

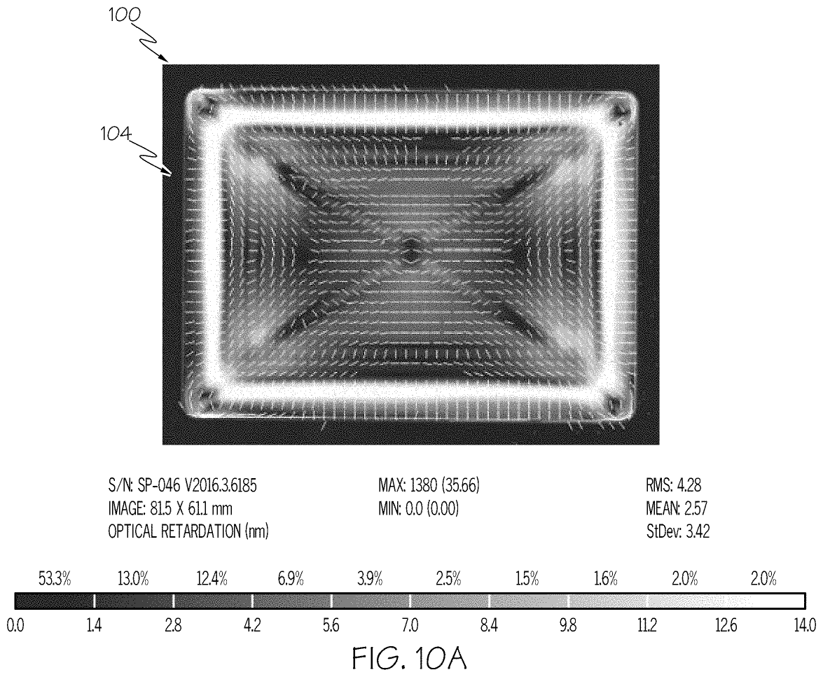

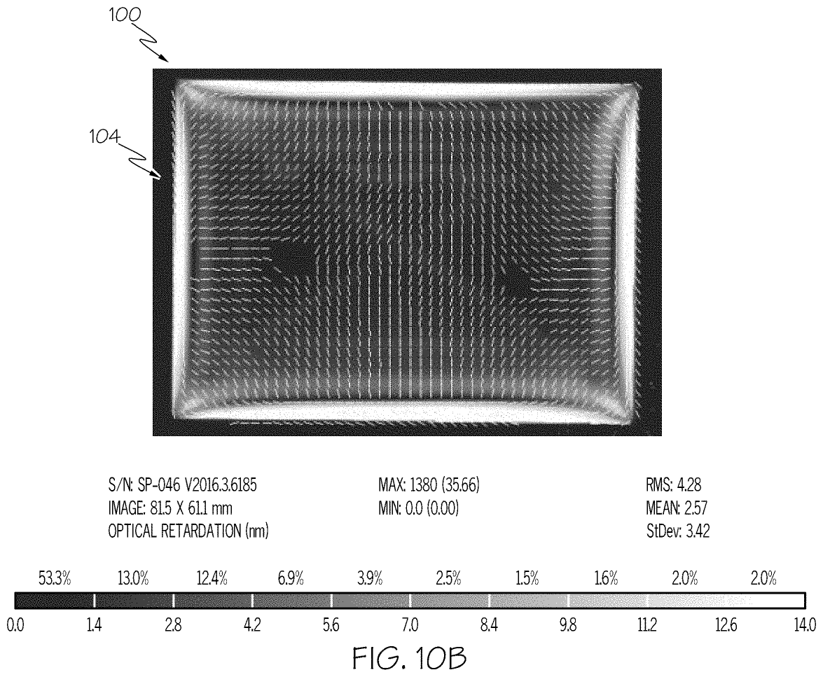

Referring again to FIGS. 3-5, the gradual cooling process from the finishing temperature to the preparation temperature at block 514 as a result of the gradual reduction of power according to block 510 and deactivation of the laser emitting device at block 512, which is quicker than a typical annealing process that lasts several hours, results in edge regions 104 of the glass sheet 100 that exhibit an amount of compressive stress, as shown in FIG. 9 when measured via retardation and in FIGS. 10A-10B when measured via strainoscope. More particularly, the strainoscope images depicted in FIGS. 10A-10B depict stress distribution whereby lines normal to the edge region 104 of the glass sheet 100 indicate compression.

Referring again to FIGS. 3-5, the glass sheet 100 can further be cooled after laser application. More specifically, the glass sheet 100 may be placed on a hotplate at block 516 for further cooling in some embodiments. For example, the glass sheet 100 may be placed on a 400° C. hotplate for further cooling. In some embodiments, the glass sheet 100 may be allowed to cool to room temperature at block 518. “Room temperature” as used herein generally refers to a temperature at which the average surface temperature of the section is about 20° C. to about 25° C. In some embodiments, the processes of placing the glass sheet 100 on the hotplate at block 516 and allowing the glass sheet 100 to cool to room temperature at block 518 may be completed over the course of a particular time period. That is, the glass sheet 100 may be allowed to cool for about 1 hour after the laser is deactivated. In some embodiments, the particular time period may generally be less than a time period that is necessary for a typical annealing process that is completed after laser finishing.

The processes described with respect to blocks 504-518 may generally be completed for each unfinished edge of the glass sheet 100. As such, a determination may be made at block 522 as to whether additional edge regions 104 of the glass sheet 100 are to be finished according to the processes described herein. If so, the process may move to block 522 and then return to block 504 for each additional edge region 104. If not, the process may move to block 524 before ending.

At block 522, the glass sheet 100 may be moved in some embodiments. That is, the glass sheet 100 may be rotated or otherwise moved to align another one of the edge regions 104 with the laser emitting device 310 for the purposes of completing the processes described with respect to blocks 504-518 again on the new edge region 104. As previously described herein, aligning the new edge region 104 may include moving one or more of the laser emitting device 310 (or a component thereof), the robot arm 322, and the support 320. For example, the robot arm 322 may be manually controlled via a user interface to align the new edge region 104 with the focused laser beam 318. In another example, the robot arm 322 and/or the laser emitting device 310 (or component thereof) may be preprogrammed to move in a particular manner at a particular time. In another example, the robot arm 322 and/or the laser emitting device 310 (or a component thereof) may be directed to move by the computing device 350. That is, the computing device 350 may transmit one or more signals to the robot arm 322 and/or the laser emitting device 310 (or a component thereof) to cause the robot arm 322 and/or the laser emitting device 310 (or a component thereof) to move accordingly.

Referring to FIGS. 1A-1B and 5, any additional downstream processes may optionally be completed at block 524 in some embodiments. For example, the glass sheet 100 may be divided into a plurality of sections 110 at block 524. That is, the glass sheet 100 may be scored and broken using any mechanical or laser-based scoring and breaking process now known or later developed. Other methods of dividing the glass sheet 100 into the plurality of sections 110 are contemplated and are included within the scope of the present disclosure. Other downstream processes, such as finishing the edges of each of the sections 110, packaging, shipping, cleaning, and/or the like, are contemplated and included within the scope of the present disclosure.

While FIG. 5 pertains to processes for finishing the edge regions 104 of the glass sheet 100, it should be understood that the processes are not limited to such. That is, the processes described with respect to FIG. 5 may also be completed for each of the section edge regions 114 of each section 110 (FIG. 1B) in some embodiments. In addition, the processes with respect to FIG. 5 may be completed for other glass articles in some embodiments. For example, the processes with respect to FIG. 5 may be completed on glass wafers to produce glass wafers with finished edges.

It should now be understood that the embodiments described herein generally relate to glass-based substrates that include one or more finished edges that are completed via a process that includes a combination of preheating the glass-based substrates to a preparation temperature, healing the edges via laser, and gradually reducing the laser power to cool the edges. As a result, the process is completed more quickly relative to other laser finishing processes that require hours long annealing steps, results in at least one edge having little or no flaws, defects, or particles, exhibiting an amount of compressive stress, and/or exhibiting little or no tensile stress.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A method of forming a glass article comprising at least one finished edge, the method comprising:
heating a substrate to a preparation temperature, the substrate comprising at least one unfinished edge;
applying a laser to the at least one unfinished edge of the substrate, the laser causing a temperature of the at least one unfinished edge to increase from the preparation temperature to a finishing temperature; and
reducing a power of the laser over a time period of at least about 10 seconds until the laser is deactivated, resulting in the glass article comprising the at least one finished edge.

2. The method of claim 1, further comprising:
scoring and breaking the glass article comprising the at least one finished edge.

3. The method of claim 1, wherein the finishing temperature is from about 1000° C. to about 1500° C.

4. The method of claim 1, wherein heating the substrate to the preparation temperature comprises placing the substrate over one or more infrared heaters until the substrate has reached an average surface temperature from about 450° C. to about 800° C.

5. The method of claim 1, further comprising:
measuring an average surface temperature of the substrate with a thermal camera; and
determining that the average surface temperature is equal to the preparation temperature prior to applying the laser to the at least one unfinished edge of the substrate.

6. The method of claim 1, wherein applying the laser to the at least one unfinished edge of the substrate comprises sweeping a focused laser beam between a first edge of the substrate and a second edge of the substrate opposite the first edge at a frequency from about 100 Hertz (Hz) to about 2 kilohertz (kHz).

7. The method of claim 1, wherein the time period is from about 30 seconds to about 60 seconds.

8. The method of claim 1, further comprising allowing the substrate to cool to an average surface temperature from about 20° C. to about 25° C. after reducing the power of the laser.

9. The method of claim 1, wherein the at least one finished edge exhibits a compressive stress of about 10 MPa to about 80 MPa.

10. A method of forming a glass article comprising at least one finished edge, the method comprising:
heating a substrate to a preparation temperature that is greater than a strain point of a glass composition of the substrate, the substrate comprising at least one unfinished edge;
applying a laser to the at least one unfinished edge of the substrate, the laser causing a temperature of the at least one unfinished edge to increase from the preparation temperature to a finishing temperature; and
reducing a power of the laser over a time period of at least about 10 seconds until the laser is deactivated, resulting in the glass article comprising the at least one finished edge.

11. The method of claim 10, further comprising:
scoring and breaking the glass article comprising the at least one finished edge.

12. The method of claim 10, wherein the finishing temperature is from about 1000° C. to about 1500° C.

13. The method of claim 10, wherein heating the substrate to the preparation temperature comprises placing the substrate over one or more infrared heaters until the substrate has reached an average surface temperature from about 450° C. to about 800° C.

14. The method of claim 10, further comprising:
measuring an average surface temperature of the substrate with a thermal camera; and
determining that the average surface temperature is equal to the preparation temperature prior to applying the laser to the at least one unfinished edge of the substrate.

15. The method of claim 10, wherein applying the laser to the at least one unfinished edge of the substrate comprises sweeping a focused laser beam between a first edge of the substrate and a second edge of the substrate opposite the edge at a frequency from about 100 Hz to about 2 kHz.

16. The method of claim 10, wherein the time period is from about 30 seconds to about 60 seconds.

17. The method of claim 10, further comprising allowing the substrate to cool to an average surface temperature from about 20° C. to about 25° C. after reducing the power of the laser.

18. A system for forming a glass-based article comprising at least one finished edge, the system comprising:
a laser emitting device;
a heating component;
a thermal imaging device; and
a computing device that is communicatively coupled to the laser emitting device, the heating component, and the thermal imaging device, the computing device configured to:
direct the heating component to heat a substrate having one unfinished edge,
receive first image data from the thermal imaging device that indicates that an average surface temperature of the substrate is about 450° C. to about 800° C.,
direct the laser emitting device to apply a laser to the at least one unfinished edge of the substrate, the laser causing an average temperature of the at least one unfinished edge of the substrate to increase to about 1300° C.,
receive second image data from the thermal imaging device that indicates that an average surface temperature of the at least one unfinished edge is about 1300° C., and
direct the laser emitting device to reduce a power of the laser over a time period of at least about 10 seconds until the laser is deactivated, resulting in the glass-based article comprising the at least one finished edge.

19. The system of claim 18, further comprising a heated vacuum chuck that holds the substrate.

20. The system of claim 18, wherein the laser emitting device further comprises an emitter, a lens, and a moving reflective surface.

21. The system of claim 18, wherein the heating component comprises a plurality of infrared heaters.
